(19) United States
(12) Patent Application Publication
(10) Pub. No.: US 2012/0261004 A1
(43) Pub. Date: Oct. 18, 2012

(54) Installation Assembly

(75) Inventor: Michele Pietroni, San Donato mil. se (MI) (IT)

(73) Assignee: Endress + Hauser Wetzer GmbH + Co. KG, Nesselwang (DE)

(21) Appl. No.: 13/518,436

(22) PCT Filed: Nov. 12, 2010
(86) PCT No.: PCT/EP10/67354

§ 371 Date: Jun. 22, 2012

(30) Foreign Application Priority Data
Dec. 22, 2009 (EP) 09180272.8

(51) Int. Cl. F16L 3/00

(52) U.S. Cl. 137/343

(57) ABSTRACT

An installation assembly with an assembly housing for accommodating at least one rod-shaped measuring insert, wherein the assembly housing has tubular first and second housing parts wherein, for accommodating the measuring insert, a first safety chamber is provided in the first housing part and a second safety chamber in the second housing part; wherein the first housing part has a process connection and wherein the first housing part is connected with the second housing part on a side of the process connection facing away from the first housing part; and wherein a seal-off apparatus is provided, which, in the case of a measuring insert introduced into the assembly housing, serves to seal off the second safety chamber from the first safety chamber, especially in a pressure-tight and/or liquid-tight manner.

The invention relates to an installation assembly.

Installation assemblies, such as, for example, those including an immersion tube, usually serve in the case of withdrawal of a measuring insert for purposes of maintenance or replacement, to close a guide tube, in which the measuring insert is inserted, and therewith, to close an opening in a container wall.

In industrial measurements technology, it is often necessary to clean or replace measuring inserts, which serve, for example, for measuring measured variables, such as pressure, temperature, fill level, flow, turbidity, conductivity and pH value. In such case, depending on the type of installation of the measuring insert, it is necessary to interrupt the process, e.g. to relieve the pressure in a container and/or to empty a container. Such interruptions are, of course, not desired. Rather, one strives, at least at times, to keep the process running, at least for a time, even in the case of a defect—such as, for example, a leakage of the installation assembly—and therewith to assure the continued functioning of the measuring arrangement.

Thus, U.S. Pat. No. 4,376,227 describes a protective tube-like assembly, which is rigidly inserted in a container, and, by means of a flange connection, adjoins on an outwardly closed off protective tube body. Serving as a sealing element is a single flange seal, which, however, in the case opening, immediately lays open the container interior.

U.S. Pat. No. 4,385,197 presents an arrangement of thermocouples, wherein a wall affixing within a protective tube system should assure good thermal contact to the measured medium and, for replacement purposes, offers a releasable, service-friendly securement.

Furthermore, U.S. Pat. No. 4,410,756 describes an apparatus, which should offer good thermal contact with the medium and an easy exchangeability, wherein thermal contact with the protective tube is only provided mechanically for the measurement-ready probe, without additional safety precautions. Also, U.S. Pat. No. 4,653,935 describes a one-chamber, high pressure embodiment, without additional safety precautions.

Furthermore, Offenlegungsschrift DE 2235676 discloses an outwardly unprotected sealing element, wherein the thermometer end is sealed directly on a container to be sealed using a screwable squeeze seal to the container, in order, for example, to enable replacement for service purposes.

Furthermore, known from Offenlegungsschrift DE 4118715 A1 is an apparatus for electrically insulated securement of a metal probe electrode in the opening of a housing. In such case, a rod electrode is introduced in an installation assembly, wherein the installation assembly has a process connection, to which a so-called housing head is directly connected, in which an associated operating electronics is located.

Known from U.S. Pat. No. 5,907,112 is a measuring probe, which has a double sealing stage. This sealing stage is formed by a tubular piece, which can be screwed on an end of the measuring probe facing away from the process. The measuring probe is then electrically contacted via the tubular piece. However, the measuring probe or its measuring insert cannot, in such case, be inserted or removed via the tubular piece.

The publication US 2005/0223781 A1 shows a measuring arrangement with a safety module, which likewise has two sealing stages. In such case, the safety module is likewise composed of a housing part, through which the measuring probe can be electrically contacted. The actual measuring probe or the measuring insert is, in such case, exposed on the process side to the measured material, and connected with the safety module via a permanent seal, via which the measuring insert cannot be replaced, without measured material escaping from the process.

An object of the invention is therefore to provide an installation assembly, which can be operated safely even in the case of leakage of the installation assembly and penetration of the measured material into the installation assembly.

The object is achieved according to the invention by an installation assembly with an assembly housing for accommodating at least one rod-shaped measuring insert, wherein the assembly housing has tubular first and second housing parts; wherein, for accommodating the measuring insert, a first safety chamber is provided in the first housing part and a second safety chamber in the second housing part; wherein the first housing part has a process connection and wherein the first housing part is connected with the second housing part on a side of the process connection facing away from the first housing part; and wherein a seal-off apparatus is provided, which, in the case of a measuring insert introduced into the assembly housing, serves to seal off the second safety chamber from the first safety chamber, especially in a pressure pressure-tight and/or liquid-tight manner.

The first safety chamber can thus be sectioned off from the second safety chamber—for example, in the case a disturbance—and thereby be sealed off, especially in a pressure-tight and/or liquid-tight manner. Therefore, safety can be assured at the measuring point—for example, according to the requirements of functional safety, i.e. SIL or ATEX—without the process needing to be paused. The interruption safety of a measuring device, for which the installation assembly is used, can thus be especially increased. In this way, for example, in the case of leakage of the first housing part, measurement can be continued. The sectioning, or sealing, off can, in such case, occur either automatically and/or manually via intervention of the operating personnel.

For this, the process connection thus includes, for example, a first side, on which the first housing part, which contains the first safety chamber, is located, and furthermore includes a second side—especially a second side lying opposite the first side—on which the second housing part, which contains the second safety chamber, is located. The first and the second safety chambers are thus, first of all, connected in such a manner that they are in communication with one another. The first and the second chambers thus form—in the defect-free or disturbance-free case—a single chamber, i.e. an interconnected, total volume, in which the measuring insert, for example, is arranged. A measured material penetrating in given cases into the assembly can thus, at first, penetrate into both the first and the second chambers. In the case of malfunction, the chamber forming the total volume can then be divided by means the seal-off apparatus into the first and second safety chambers, so that the first and the second chambers are sealed off from one another in a pressure-tight and/or liquid-tight manner. In this way, for example, the measured material, which has penetrated into the assembly via leakage in the installation assembly in the region of the first housing part, can be held within the first housing part or the first safety chamber and can be contained there. A further penetration of the measured material into the second safety chamber is thereby prevented.

The assembly as such is thus composed, for example, of the first and second housing parts or the two safety chambers contained therein, and a connection head connected to the second housing part or the second safety chamber contained therein, which contains a measuring and/or operating electronics. A measuring insert, especially an extractable measuring insert, is inserted, or at least insertable, into the assembly.

An amount of measured material, once it has penetrated into the second housing part, can then be isolated from the rest of the measured material by closing the seal-off apparatus. The second safety chamber can then be cleaned of the measured material, for example, by rinsing. This is especially advantageous in the case of strongly corrosive or especially hot, measured substances, because thereby, a measuring and/or operating electronics—which, for example, is accommodated in a third housing part adjoining the second housing part and especially sealed off therefrom—thereby does not come into danger of being damaged by measured material penetrating into it.

The seal-off apparatus can even be closed, and the first safety chamber sectioned off from the second safety chamber, when the measuring insert is located partially in the first safety chamber. The seal-off apparatus can thus also be closed in the case of measuring inserts inserted into the assembly, or, more exactly stated, into the first and the second safety chamber. The second housing part and the second safety chamber contained therein thus serve, like the first housing part and the first safety chamber, for accommodating the measuring insert. For accommodating the measuring insert, the seal-off apparatus can have, for example, a bore, through which the measuring insert is led into the first safety chamber. By means of at least one sealing means, the bore, including the part of the measuring insert led through the bore, can then be closed, so that the first safety chamber is isolated and sealed off from the second safety chamber, especially in a pressure-tight and/or liquid-tight manner. Furthermore, the sealing between the first and the second safety chamber can be gas-tight. If a number of measuring inserts are present, these can then, for example, be led together through one bore in the seal-off apparatus, or each measuring insert can have its own bore through the seal-off apparatus. Sealing means for closing all the bores are then to be correspondingly provided.

The first safety chamber can serve essentially to protect the measuring insert from a measured material, while the second safety chamber serves, if need be, to protect the process environment from measured material which has penetrated into the installation assembly. The seal-off apparatus between the first and the second safety chamber can in this way act as an additional sealing stage between the measured material and the process environment—above all, a remotely situated, control room. As already mentioned, the first safety chamber can be contained in the first housing part. The first housing part thus forms, in such case, the environmental boundary of the installation assembly, and thereby offers protection for the measuring insert provided in the first housing part against the measured material contacted during operation. In the installed state, the first housing part is then arranged within a container and exposed to the measured material, while the second housing part is arranged outside of the container in which the first housing part is located. In such case, the installation assembly is mounted on the container via the process connection.

With only one safety chamber, such as is known from the state of the art, the maintaining of a temperature limit, as is, for example, required by the ATEX guideline T6, cannot be assured. For, upon leakage of, for example, a protective tube, i.e. the first housing part, the measured material would fill the safety chamber and possibly heat it to higher temperatures than allowable. Via the seal-off apparatus and the second safety chamber, a penetrating measured material, can, however, be held within the first protective chamber—i.e. within the installation assembly which, for example, is composed of a protective tube—so that the measured material cannot penetrate further than up to the process connection. In this way, the surface temperature at the location of the installation assembly can be held below the limit value required, for example, by the ATEX guideline T6. Thus, in the case of a defect, such as, for example, leakage of the first housing part, the same safety rating can be kept as in the defect free case.

It should also be mentioned that recently, robust measuring inserts have become known, which, even in the case of a leakage, and subsequently an entering of possibly corrosive measured material into the installation assembly, still remain functionally capable. These robust measuring inserts have, for example, a supplemental coating or layer, which lengthens their lifespan. Additionally, with a closed seal-off apparatus, contamination of the measured material due to cleaning agents possibly applied for cleaning the second safety chamber can be prevented.

In an embodiment of the installation assembly, the seal-off apparatus seals the first safety chamber off from the second safety chamber in the region of the process connection. It can thus can be prevented, that, for example, in the case of high process temperatures, measured material in given cases penetrating into the safety chamber heats the region of the installation assembly above the process connection, especially the surface of such region.

In an additional embodiment of the installation assembly, the seal-off apparatus is arranged—especially directly—between the process connection and the second housing part or the second safety chamber. In this way, the measured material can be constrained from leaving the first housing part—which serves, for example, as a protective shield—so that, as mentioned, heating up, especially of the surface of the installation assembly, can be prevented.

In an additional embodiment of the installation assembly, the assembly housing includes a third housing part connected with the second housing part, wherein this third housing part serves for accommodating a measuring and/or operating electronics. The third housing part can be, for example, a measurement transmitter housing, especially a so-called connection head, and be isolated via another sealing stage from the second safety chamber. As a result, a measured material, which has in given cases penetrated into the second safety chamber, cannot directly escape from the installation assembly, or travel through a tubular system connected to the third housing part into a control room. By closing the seal-off apparatus, in the case of leakage of the first housing part, a double sealing is present between the third housing part and/or a control room and the measured material located in the process, so that, even in the case of a defect, the measuring device applied with the installation assembly can safely be further operated. The third housing part can be arranged so as to be connected with the second housing part and especially at an end of the second housing part opposite the end of the second housing part connected via the process connection with the first housing part. While the first and the second housing parts, as well as the first and the second safety chambers, serve for accommodating and/or leading the measuring insert, the third housing part serves to accommodate the measuring and/or operating electronics for measuring insert. In such case, the operating electronics is composed, for example, of electronic components or is assembled from these. The first and second housing parts are accordingly preferably free of electronic components, and thus contain no electronic components serving for conditioning and/or processing the measurement signal registered by means of the measuring insert.

In an additional embodiment of the installation assembly, at least the first, second and third housing parts are connectable with one another, and the assembly housing is modularly assembled essentially from the three housing parts. The housing parts of the installation assembly can, for example, be connected with one, another via screwed connections. Thus, the second housing part can be screwed onto the process connection—embodied, for example, as a flange—of the first housing part. Alternatively, an option is to use an, at least partially, one-piece construction, i.e. at least the first and the second and/or the third housing part form one unit, and thus, especially, are connected with one another by material bonding.

In an additional embodiment of the installation assembly, the first housing part is mounted by means of the process connection on an opening of a container, and protrudes into the container. In an additional embodiment of the installation assembly, during measurement operation, the first housing part is exposed on its outside to a measured material. In an additional embodiment of the installation assembly, the second housing part adjoins the first housing part but lies outside of the container. By the division into, on the one hand, the first housing part exposed to the measured material within the container, and, on the other hand, the second housing part arranged outside of the container and by arranging the seal-off apparatus therebetween, an advantageous effect as regards the reliability of the installation assembly can be achieved.

In an additional embodiment of the installation assembly, the seal-off apparatus serves in the case of leakage of the first housing part to seal off the second housing part from the first housing part, especially in a pressure-tight and/or liquid-tight manner, without interrupting measurement operation. The measuring insert remains, in such case, within the installation assembly, and the measuring insert especially remains in an arrangement within the installation assembly unchanged in comparison to the arrangement in the defect free measurement operation. The measuring insert can, consequently, both in the case of an opened as well as also in the case of a closed seal-off apparatus, be arranged in the first safety chamber as well as also in the second safety chamber. The measuring insert, which is at least partially arranged in the first and second safety chambers, should, in order to allow the measurement operation to be continued, consequently not be damaged by the sealing off action. As mentioned, for isolating the safety chambers, a sealing means can be provided, and be used, for example, to close the bore of the seal-off apparatus, through which the measuring insert is led. The measurement operation of the measuring device, which the installation assembly uses, can thus be continued, since the measuring insert, for example, in the case of temperature measurement, is still in thermal contact with the measured material.

In an additional embodiment of the installation assembly, the seal-off apparatus comprises a sealing segment, which is connectable to the first housing part. The second housing part can have, for example, a cavity, into which the sealing segment fits. The sealing segment can then be connected with the first housing part, for example, by securing the second housing part to the first housing part by force interlocking, e.g. friction interlocking, and/or shape interlocking, especially in a pressure-tight, gas-tight and/or liquid-tight manner. Alternatively, the sealing segment, like the entire seal-off apparatus, can be integrated or inserted into the second housing part. The sealing segment can especially serve as a connection between the first safety chamber located in the first housing part and the second safety chamber located in the second housing part.

In an additional embodiment of the installation assembly, the sealing segment further includes at least one bore, which serves for accommodating or guiding the at least one measuring insert. In the installed state, the measuring insert is thus, for example, led through the seal-off apparatus. The measuring insert can especially be led through a bore provided in the seal-off apparatus, especially in the sealing segment. Via the bore provided in the seal-off apparatus for accommodating the measuring insert, the first and the second safety chambers can be connected with one another. By closing the seal-off apparatus, this connection can then be broken, and the first safety chamber separated from the second safety chamber. The sealing can, in such case, be embodied in a liquid-tight and/or pressure-tight or also gas-tight manner.

In an additional embodiment of the installation assembly, the bore for accommodating the measuring insert also serves for accommodating a compressible sleeve—especially a compressible sleeve essentially composed of graphite—wherein this compressible sleeve, in turn, serves for accommodating the at least one measuring insert. In such case, the compressible sleeve surrounds the measuring insert in the region of the bore at least sectionally along, the longitudinal axis of the measuring insert. The compressible sleeves can, as is explained in the following, serve as sealing means, for closing the bore.

In an embodiment of the installation assembly, pressure applying sleeves are furthermore provided in the sealing segment, wherein these pressure applying sleeves serve to bring about a compression of the compressible sleeves, and thereby to seal off the first safety chamber from the second safety chamber, especially in a pressure-tight and/or liquid-tight manner. The pressure applying sleeves can be, for example, stops for the compressible sleeve around the measuring insert, wherein the stops are produced by means of drilling. If the compressible sleeve surrounding the measuring insert is pressed against the pressure applying sleeve, the compressible sleeve can deform. The deformation of the compressible sleeve can be utilized to fill, with the material of which the compressible sleeve is composed, an intermediate space existing between the measuring insert and the wall of the bore. It has proven advantageous to use graphite as the material for the compressible sleeves, since, on the one hand, graphite is soft and, consequently, can be deformed by means of applied pressure, and, on the other hand, graphite is heat resistant. Naturally, also other materials with similar properties can be used, materials such as, for example, molybdenite.

In an additional embodiment of the installation assembly, the sealing segment includes a bore for accommodating a pressure piston, wherein this pressure piston effects the compression of the compressible sleeve. The pressure piston can transfer a force transferred to it in turn further onto the compressible sleeve, and press this against the pressure applying sleeve, so that the compressible sleeve around the measuring insert is deformed, and therewith seals off the bore, based on the deformation of the compressible sleeve at least partially filling out the bore. The pressure piston can, for example, transfer a force in the longitudinal direction of the compressible sleeve, so that the compressible sleeve, in the case of a force, which exceeds the stiffness of the compressible sleeve in the longitudinal direction, begins to deform.

In an additional embodiment of the installation assembly, in the case of leakage of the first housing part, the seal-off apparatus automatically seals off the first housing part from the second housing part, especially in a pressure-tight and/or liquid-tight manner. For such purpose, for example, a pneumatic actuator can be provided. For such purpose, a monitoring connection can be provided, whose signal output, in the case of the exceeding of a limit operational pressure, switches, for example, a control element, which, for example by means of hydraulic or pneumatic actuators, effects the closing of the seal-off apparatus.

In an additional embodiment of the installation assembly, the pressure piston is actuated via pressure buildup in the case of leakage by leading pressure from the first safety chamber via a pressure line through the process connection with the process pressure transferred via the measured material, from which an intrinsic closing function results.

In an additional embodiment, in the case of leakage of the first housing part, the seal-off apparatus is embodied for automatically sealing off the first housing part from the second housing part, especially in a pressure-tight and/or liquid-tight manner.

In an additional embodiment, in the case in which the automatic seal-off apparatus becomes partially or completely ineffective, supplementally, at a monitoring connection, a pressure monitoring unit is connected, whose signal output, in the case of the exceeding of a limit operating pressure, switches in a control element, which, by means of hydraulic or pneumatic actuators, effects the closing off of the first safety chamber from the second safety chamber.

The invention will now be explained in greater detail on the basis of the appended drawing, the figures of which show as follows:

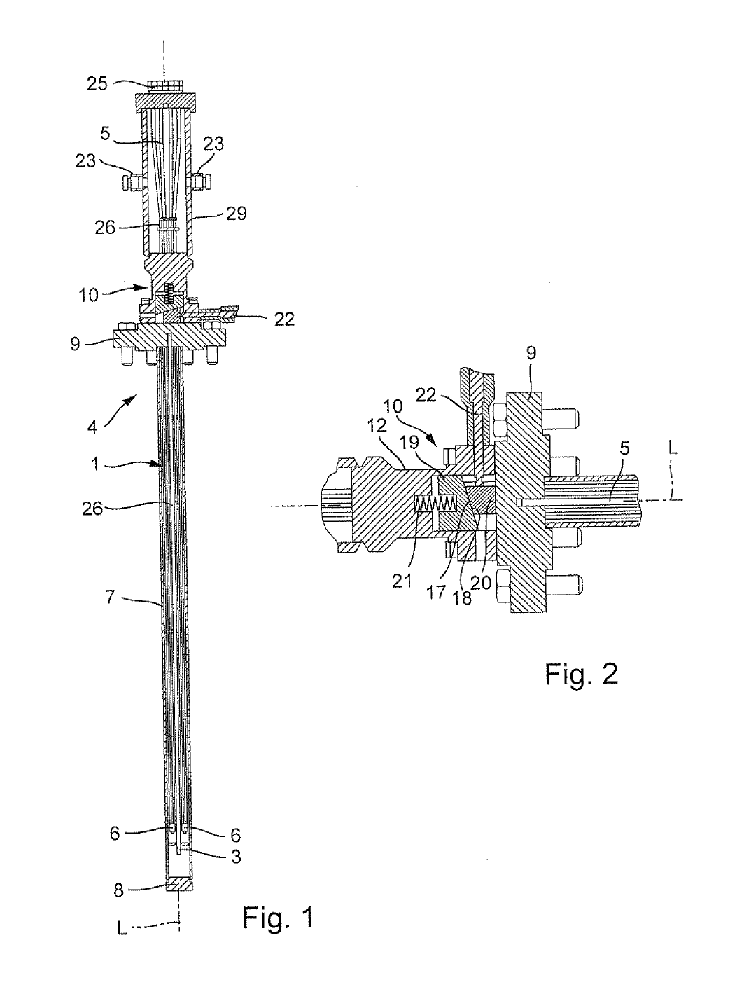

FIG. 1 a section containing the longitudinal axis of an installation assembly having a plurality of rod-shaped measuring inserts,

FIG. 2 a section containing the longitudinal axis of the installation assembly at the height of the seal-off apparatus,

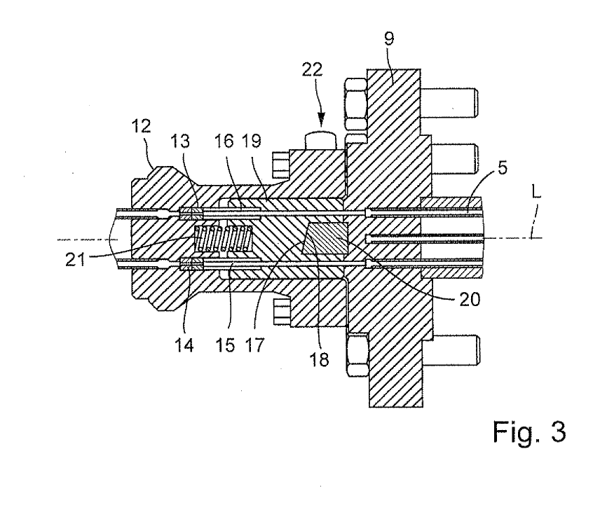

FIG. 3 a additional section containing the longitudinal axis of the installation assembly at the height of the seal-off apparatus, however, on a plane offset with respect to FIG. 2 by a rotational angle around the longitudinal axis, and

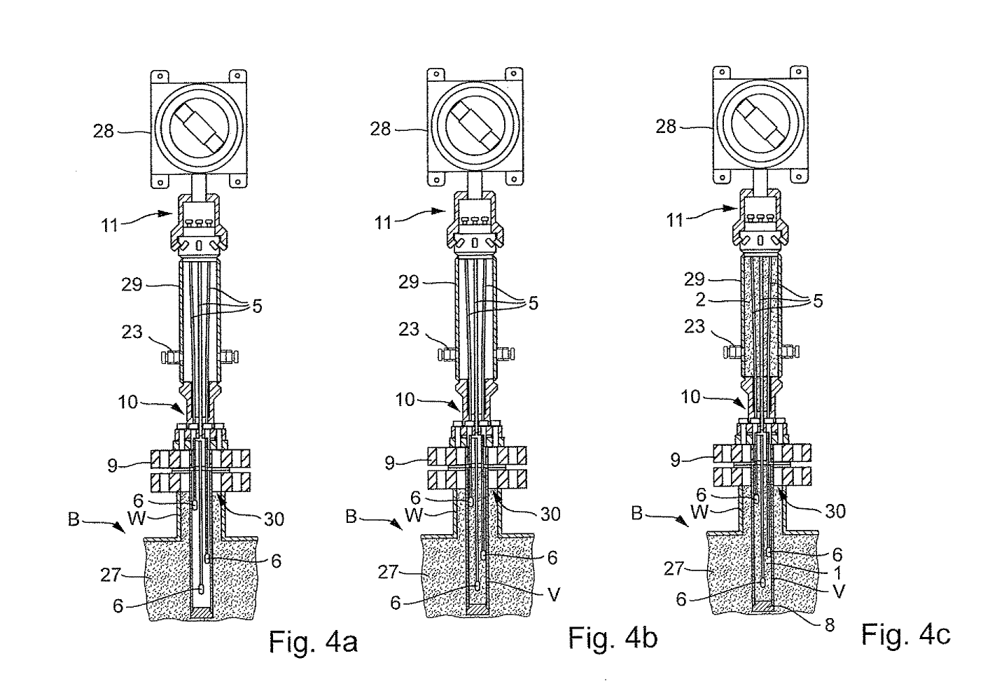

FIG. 4 a section through an installed installation assembly a) in the defect free operating state, b) in the case of leakage and a filled first safety chamber, c) in the case of leakage and filled first and second safety chambers.

FIG. 1 shows a section containing the longitudinal axis L of the installation assembly 4. Installation assembly 4 is composed, in such case, of an immersion tube 7, which in the installed state is at least partially exposed to a measured material 27, and serves as a protective shield against measured material 27. The immersion tube 7 forms a first housing part of installation assembly 4. At an end of this immersion tube 7, a process connection 9 is present in the form of an installation flange, which serves for securing installation assembly 4 to the wall of a container, in which measured material 27 is located. Above the process connection 9, i.e. on the side of process connection 9 facing away from immersion tube 7, a seal-off apparatus 10 is arranged and connected with immersion tube 7. The seal-off apparatus 10 is received by a second housing part 29, which likewise is arranged above immersion tube 7, i.e. on the side of process connection 9 facing away from immersion tube 7. The second housing part 29 is connected here via a clamping screw unit 25 with a third housing part (not shown in FIG. 1). Arranged within the first housing part—i.e. immersion tube 7—and the second housing part 29 are a plurality of measuring inserts 5. These measuring inserts 5 can serve, for example, for recording the temperature of a measured material, especially at a plurality of points on the first housing part 7. For such purpose, the temperature inserts 5 can include, for example, temperature sensors 6.

Immersion tube 7 terminates on one end at the process connection 9. Immersion tube 7 is sealed on the end lying opposite process connection 9 with a plug 8. At the end of the installation assembly 4 sealed with plug 8, a pressure tube 3 is provided, which receives a pressure arising at the end and conveys this to the seal-off apparatus 10, respectively the process connection 9. Immersion tube 7 forms a first safety chamber 1, i.e. it surrounds a hollow space, in which the measuring inserts 5 are arranged. For positioning the measuring inserts 5, clamping holders 26 are also provided in the first safety chamber 1.

Seal-off apparatus 10 is arranged on the side of process connection 9 facing away from immersion tube 7, between process connection 9 and the second safety chamber 2. In defect free, measurement operation, the first and the second safety chambers 1, 2 are connected with one another, for example, via seal-off apparatus 10.

Within the second safety chamber 2, the measuring inserts 5 are likewise positioned by means of clamping holders 26. Additionally, the second housing part includes monitoring connections 23, by means of which the second safety chamber 2 can be monitored for entering measured material. The monitoring connections 23 can, for example, also be valves. Additionally, the monitoring connections 23 can also serve for rinsing or washing, i.e. cleaning the second safety chamber 2.

FIG. 2 shows a section containing the longitudinal axis L of installation assembly 4 and presenting details at the height of seal-off apparatus 10. The illustrated embodiment of seal-off apparatus 10 will now be described in the following in greater detail.

Seal-off apparatus 10 is arranged directly between process connection 9, which is secured to immersion tube 7, and the second housing part 29. The measuring inserts 5 are, in such case, led through seal-off apparatus 10. Seal-off apparatus 10 serves, in such case, to isolate the first safety chamber 1 from the second safety chamber 2. For such purpose, a press rod 22 can be provided, by means of which a wedge shaped body 20 experiences a shifting force, so that the wedge shaped body 20 acts with a pushing side 18 against a pressure piston 19. Via the pressure piston 19, which especially has a prismatic shape, the graphite sleeves 14 surrounding the measuring inserts 5 are compressed by pressure applying sleeves 15, so that, by the deformation of the sleeves 14, the bores 13, through which the measuring inserts 5 are led, are sealed.

For biasing the pressure piston 19, for example, a spring 21, can be provided, which is arranged between the pressure piston 19 and a wall of the second housing part 29.

Alternatively or supplementally, the seal-off apparatus can be caused to seal by pressure transferred via the pressure receiving tube 3. For such purpose, a duct (not shown in FIGS. 2 and 3) can be provided, which transfers the pressure from pressure receiving tube 3 through process connection 9 to the wedge shaped body 20, and thereby leads to compression of the sleeves 14.

FIG. 3 shows again a section containing the longitudinal axis L of the installation assembly 4 and situated at the height of the seal-off apparatus 10. FIG. 3 shows the sleeves 14, which surround the measuring inserts 5, and the pressure applying sleeves 15 of the seal-off apparatus 10.

FIG. 4 likewise shows a section containing the longitudinal axis L of an installed installation assembly a) in the defect free operating state, b) in the case of leakage V and filled first safety chamber, and c) in the case of leakage V and filled first and second safety chambers 1, 2. The operation of installation assembly 4 will now be explained again based on the states shown in FIG. 4.

In FIG. 4a), the installation assembly 4 is shown in the defect free state. The first housing part of installation assembly 4, i.e. immersion tube 7, is mounted at an opening 30 of a wall W of the container C by means of process connection 9. Outside of container C, the second housing body 29 is connected at one end to the process connection 9 of immersion tube 7, while at the oppositely lying end, a third housing part, namely the measurement transmitter housing 28, is connected. Measurement transmitter housing 28 is, in such case, connected to the second housing part 29via a so-called assembly head 11. No measured material has leaked into either of the first and second safety chambers 1, 2 in FIG. 4a).

FIG. 4b) shows the case, in which, due to damage (in this case, leakage V) to the first housing part, i.e. to immersion tube 7, measured material 27 has penetrated into the first safety chamber 1.

In FIG. 4c), the measured material 27 from the leak V has completely filled the first and the second safety chambers 1, 2.

The seal-off apparatus 10 of the proposed installation assembly 4 can be used to seal off the installation assembly at the height of the process connection 9. In this way, a measured material 27 possibly penetrating into the installation assembly 4 can be kept henceforth within the container C, and thus heating up of the surface of installation assembly 4 can be prevented.

The installation assembly 4 shown in FIG. 4 can also be used to replace the measuring inserts 5 while a process is still running. For this purpose, the measuring inserts 5 are first pulled from the first safety chamber 1 into the second safety chamber 2. Then, seal-off apparatus 10 can be closed. The second safety chamber 2 can then be freed of measured material 27, for example by rinsing. The measuring inserts 5 can then be replaced. Following this, seal-off apparatus 10 can be opened again, and the measuring inserts 5 inserted back into the first safety chamber 1.

### LIST OF REFERENCE CHARACTERS

1 first safety chamber

2 second safety chamber

3 pressure receiving tube

4 installation assembly

5 measuring insert

6 temperature sensor element

7 immersion tube

8 plug

9 process connection

10 seal-off apparatus

11 assembly head

12 sealing segment

13 bore in the sealing segment for accommodating sleeves

14 compressible sleeve

15 pressure applying sleeve

16 bore in the sealing segment for accommodating a pressure piston

17 inclined plane

18 pushing side

19 pressure piston

20 prismatic wedge body

21 spring

22 press rod

23 monitoring connection

24 extending part

25 clamping screw unit

26 clamping holder

27 measured material

28 transmitter housing

29 second housing part

30 opening in the container wall

C container

L longitudinal axis of the installation assembly

V leakage

W wall of the container

1-15. (canceled)

16. An installation assembly, comprising:
at least one rod-shaped insert;
an assembly housing for accommodating said at least one rod-shaped measuring insert, said assembly housing has tubular first and second housing parts;
a first safety chamber, for accommodating said at least one rod-shaped measuring insert, said first safety chamber is provided in said first tubular housing part; and
a second safety chamber in said second tubular housing part, wherein:
said first tubular housing part has a process connection; and
said first housing part is connected with said second tubular housing part on a side of the process connection facing away from said first tubular housing part; and
a seal-off apparatus is provided, which, in the case of said at least one rod-shaped measuring insert introduced into said assembly housing, serves to seal off said second safety chamber from said first safety chamber, especially in a pressure-tight and/or liquid-tight manner.

17. The installation assembly as claimed in claim 16, wherein:
said seal-off apparatus seals off said first safety chamber from said second safety chamber in the region of the process connection.

18. The installation assembly as claimed in claim 16, wherein:
said seal-off apparatus is arranged—especially directly—between the process connection and said second housing part or said second safety chamber.

19. The installation assembly as claimed in claim 16, wherein:
said assembly housing has a third housing part connected with said second housing part and serving for accommodating measuring and/or operating electronics.

20. The installation assembly as claimed in claim 16, wherein:
at least said first, said second and said third housing parts are connectable with one another; and
said assembly housing is modularly assembled essentially from said three housing parts.

21. The installation assembly as claimed in claim 16, wherein:
said first housing part is mounted by means of the process connection on an opening of a container, and protrudes into the container.

22. The installation assembly as claimed in claim 16, wherein:
during a measurement operation, said first housing part is exposed on its outside to a measured material.

23. The installation assembly as claimed in claim 16, wherein:
said second housing part adjoins said first housing part but lies outside of the container.

24. The installation assembly as claimed in claim 16, wherein:
said seal-off apparatus serves in case of leakage of said first housing part to seal off said second housing part from said first housing part, especially in a pressure-tight and/or liquid-tight manner, without interrupting measurement operation.

25. The installation assembly as claimed in claim 16, wherein:
said seal-off apparatus comprises a sealing segment, which is connectable to said first housing part.

26. The installation assembly as claimed in claim 25, wherein:
said sealing segment further includes at least one bore, which serves for accommodating or guiding said at least one measuring insert.

27. The installation assembly as claimed in claim 26, wherein:
said bore for accommodating said measuring insert also serves for accommodating a compressible sleeve, especially a compressible sleeve essentially composed of graphite; and
said compressible sleeve in turn serves for accommodating said at least one measuring insert.

28. The installation assembly as claimed in claim 26, wherein:
a pressure applying sleeve is furthermore provided in said sealing segment;
said pressure applying sleeve serves to bring about a compression of said compressible sleeve and thereby to seal off said first safety chamber from said second safety chamber, especially in a pressure-tight and/or liquid-tight manner.

29. The installation assembly as claimed in claim 26, wherein:
said sealing segment includes a bore for accommodating a pressure piston, said pressure piston effects the compression of said compressible sleeve.

30. The installation assembly as claimed in claim 16, wherein:
in the case of leakage of said first housing part, said seal-off apparatus automatically seals off said first housing part from said second housing part, especially in a pressure-tight and/or liquid-tight manner.
